(19) United States
(12) Patent Application Publication
(10) Pub. No.: US 2003/0225883 A1
(43) Pub. Date: Dec. 4, 2003

(54) System and method for reliable delivery of event information

(75) Inventors: Jon Darren Greaves, South Riding, VA (US); Paul Hughes, Arlington, VA (US); Chun Chau Ma, Reston, VA (US); Michael Seminaro, Arlington, VA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: SevenSpace, Inc.

(21) Appl. No.: 10/452,933

(22) Filed: Jun. 3, 2003

Related U.S. Application Data
(60) Provisional application No. 60/384,392, filed on Jun. 3, 2002.

(51) Int. Cl. G06F 15/173

(52) U.S. Cl. 709/224; 709/217

(57) ABSTRACT

The present invention provides a system capable of low cost monitoring and/or management solutions that can be deployed into data centers and into other systems that may not contain a particular management system. The system supports the monitoring and/or management of numerous devices. In some illustrative embodiments, these devices can include any combination of servers or appliances. A method for the secure and reliable delivery of reactive, proactive and/or predictive event information provided by unreliable protocols over an Internet connection is provided. The method preferably provides encryption, encapsulation, store and/or forward services and confirmation of such events.

### CROSS REFERENCE TO RELATED APPLICATIONS

This application claims priority under 35 U.S.C. §119(e) to U.S. Provisional Patent Application No. 60/384,392, “System and Method for the Reliable Delivery of Event Information,” filed Jun. 3, 2002, which is hereby incorporated by reference.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates to the monitoring and management of devices or appliances using a management system and the like.

2. Description of the Related Art

Maintaining efficient, high-performance information technology (IT) operations is imperative to success in today's corporate environment. To meet this challenge, businesses have a variety of options available to them. For example, a business may hire an internal staff of experts, outsource their entire IT operations, use existing employees to double as IT professionals, or a implement combination of alternatives. Outsourcing is a partnership in which an IT management company renders services and/or resources to another company upon its request. Outsourcing is a modern trend that is becoming more widespread in the information technology field.

The various options for IT management each carry an array of drawbacks. The growing complexity of IT and the difficulty to find and retain trained IT staff are key outsourcing advantages justifying the use of IT outsourcing services. Managing complex IT applications internally is time consuming and expensive. Retaining the right resources and applying cutting edge technologies may be difficult and very expensive to many businesses. To eliminate the hardships of IT procurements, maintenance, staff recruitment, retention, and training, an outsourced staff of IT professionals may perform as an organization's IT department. Such services allow an organization to concentrate on its core business and not IT. Such services may be especially helpful for small and medium sized businesses whose computer infrastructures are too small for full-time IT administrators, but have grown too complex for employees to manage effectively.

The practice of outsourcing may account for between 10 percent and 25 percent of corporate IT budgets. However, there is no easy profile that these users of outsourcing fit. Utilizing the services of an outside provider may allow the customer little, if any, control over the applied IT management systems. Where outsourcing requires the transmission of data outside the organization, security is also a concern. For example, maintaining the security of sensitive financial data in outsourced IT environments may be an area of great importance for a bank or other financial institution. Thus, business leaders must weigh the cost savings of farming out work against concerns about surrendering security and control.

For outsourcing provider to provide cost effective services, there must be minimal client expenditure for IT system applications. It would be beneficial to both the outsourcing clients and providers if the outsourced IT management systems could be operated with minimal implementation costs and without the need for additional equipment. Furthermore, these IT system applications must be compatible with numerous network configurations and appliances. Also, there is a need to provide IT management services at a central off-site location, so that a single group can coordinate IT management services for numerous businesses. Data must be able to be securely transmitted from a client location to the IT management group. Additionally, outsourcing applications must be flexible to accommodate changes in client software, hardware or business strategies.

In an increasingly competitive economy, IT budgets continue to shrink, and business requirements for information technology are steadily increasing. To meet this challenge, businesses struggle between improving current IT operations performance and meeting the demands of new, strategic initiatives. The inherent tension of utilizing limited resources to both stabilize and improve operations while deploying new applications and infrastructure requires a flexible, innovative solution. What is needed is an outsourcing solution that augments the overall efficiency of IT departments. More specifically, businesses need to be able to increase the performance of their systems, refocus on strategic IT initiatives and reduce their operations costs, without losing control over their infrastructure.

Summarizing, various limitations of current IT management platforms include, for example, the lack of centralized management capability—translating to higher operational cost; the inability to resolve IP conflicts among customer devices; the need of a virtual private network (VPN) set up between certain locations—translating to additional infrastructure and support cost; and the lack of local event filtering capabilities (e.g., eliminating background noise transmitting from an operations center).

### BRIEF SUMMARY OF THE INVENTION

The present invention solves the aforementioned limitations by providing a system capable of, among other things, low cost monitoring and/or management solutions that can be deployed into data centers and into other systems that may not contain a particular management system. These data centers may include, for example, either a customer's enterprise data center or another location where a management system has not been deployed.

In some illustrative embodiments, the system supports the monitoring and/or management of numerous devices (e.g., up to 250 devices or more in some illustrative embodiments, depending on the connection capabilities of the associated commercially available hardware). In some illustrative embodiments, these devices can include any combination of servers or appliances. One illustrative and non-limiting implementation of such a system is described under the trade name Control Tower™ (CT).

In some preferred embodiments, a method for the secure and reliable delivery of reactive, proactive and/or predictive event information provided by unreliable protocols (such as, e.g., primarily Simple Network Management Protocol (SNMP) and/or Syslog) over an Internet connection is provided. The method preferably provides encryption, encapsulation, store and/or forward services and confirmation of such events.

In preferred embodiments, deployment of the system is built on a client/server paradigm. A client application (also referred to as Control Tower Appliance™ (CTA) in some illustrative embodiments) is preferably housed within the local infrastructure of the device(s) providing event information. For instance, the CTA may be located local to a client, such as on a local network, intranet or the like. The server application (also referred to as Control Tower Server™ (CTS) in illustrative embodiments) is preferably located in a remote data center.

Preferred embodiments provide reliable delivery of event information performed using encryption and encapsulation (e.g., in extended markup language (XML)). In various embodiments, such event information can include substantially any information that may not be delivered as reliably as desired. The preferred embodiments of the invention may be used to monitor substantially any type of device, appliance, infrastructure, or system, such as, in merely some examples, routers/switches (such as, e.g., Cisco® Routers/Switches, Foundry® Routers/Switches, Lucent(Routers/Switches, Extreme Networks® Switches, Cisco® VPN Concentrators, Nortel® VPN Devices), gateways, web servers (such as, e.g., Microsoft® IIS Apache, iPlanet™, Netscape®), application servers (such as, e.g., SEA WebLogic, ATG Dynamo, iPlanet™, IBM Web Sphere™, GemStone®, Jakarta Tomcat™), messaging servers (such as, e.g., iPlanet™ Message Server, iPlanet™ Messaging Queue for Java, Send Mail—SMTP, Microsoft® Exchange 5.5, Microsoft® Exchange 2000, Netscape® Messaging Server), database environments (such as, e.g., DS2, Oracle®, SOL, Sybase), firewalls (such as, e.g., Checkpoint®, Cisco®, Nokia®), computer systems (such as operating systems, such as, e.g., Sun Solaris, Linux®, AIX, OS/400, Windows® 2000, Windows® NT 4.6, Windows® 2000 Advanced), load balancers (such as, e.g., Arrowpoint™, Alteon™, Cisco®, F5 Sig IP, Foundry®), LDAP, processors, cameras, video systems and any other electronic device, application or system capable of providing event information of any kind over a network. The event information can include anything that may be able to be electronically transmitted, such as, for example, signals, data, documents, text, images, audio, video and more.

In some illustrative embodiments, the event information can include reactive information that is reactive to an occurrence, such as reactive to an occurrence in the device or appliance, or detected or otherwise made known to the device or appliance. For example, reactive information can include information outputted to the monitoring system based on local detection of system problems or the like. In some illustrative embodiments, the event information can include proactive information that is provided to the monitoring system based on the monitoring system's exercising of functionality to obtain such information, such as, e.g., pinging the device or system under certain conditions or the like. In some illustrative embodiments, the event information can include reporting information, such as the measuring of transaction trends over time or the like.

Illustrative embodiments of the present invention can be employed in a computer system having one or more computers. Some illustrative computer systems can include a computer network (e.g. such as the world wide web, the Internet, a wide area network (WAN), an intranet, any other network of computers, a combination of such networks, or the like) having at least one client device (e.g., server, computer [e.g., personal computer, laptop computer, personal digital assistant or any other computer device or system], router, firewall or other device) and at least one server for monitoring and/or managing the client device(s) via the network. In illustrative embodiments, servers and/or computers and/or devices or appliances can include that which is currently known or that which will be known or developed. For instance, illustrative computers and/or servers can include, e.g.: a central processing unit; memory (e.g., RAM, etc.); digital data storage (e.g., hard drives, etc.); input/output ports (e.g., parallel and/or serial ports, etc.); data entry devices (e.g., key boards, etc.); etc. In some instances, client computers may contain software for interacting with the server(s), such as, for example, using hypertext transfer protocol (HTTP) to make requests of the server(s) via the Internet or the like.

It is an aspect of the present invention to provide an event delivery system that has centralized management capability.

It is a further aspect of the present invention to provide an event delivery system that has the ability to resolve IP conflicts among customer devices.

Additionally, it is an aspect of the present invention to provide an event delivery system that can transmit data securely without the need of a VPN setup between remote locations.

It is also an aspect of the present invention to provide an event delivery system that provides local filtering capabilities to eliminate transmission of unnecessary event data.

The preferred embodiments of the present invention can, in some cases, provide various benefits in some embodiments, such as reduced installation resources; better reports; better customer information; and/or cost savings and avoidance, including use of customer's existing bandwidth, substantially no cross connects, and/or no cage space.

In some illustrative embodiments, some or all of the following features can be employed: SNMP trap reception; Syslog message reception; local event filtering; ISM-like ICMP and SNMP polling; jump gate access to managed devices (such as SSH, Terminal Services, VNC, and the like); administration by a centralized manager; HTTP with encrypted payload for transmission of events (e.g., no VPN needed); generic XML representation of events; low cost, reliable hardware (such as a CTA); and/or clustered control tower servers. Other feature of the present invention may include: data collection for SNMP and non-SNMP based metrics for reporting; support for addition service monitoring in HTTP, POP3, IMAP; SMTP; HTTPS, LDAP in the CTA; and a user interface for a CT manager.

While some preferred embodiments of the invention are described herein, the present invention is not limited thereto, but includes any and all modifications, adaptations, variations, additions and deletions as would be apparent to those in the art based on this disclosure.

### BRIEF DESCRIPTION OF THE DPAWINGS

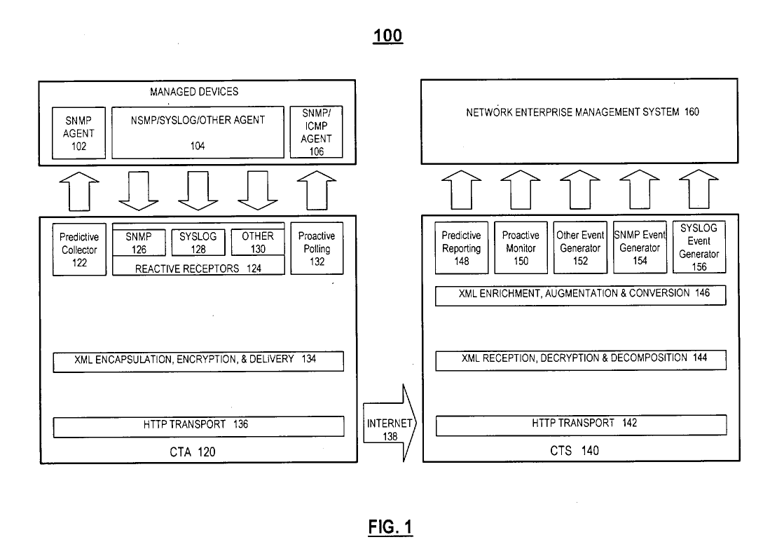

FIG. 1 illustrates the information flow and key components in one embodiment of the present invention;

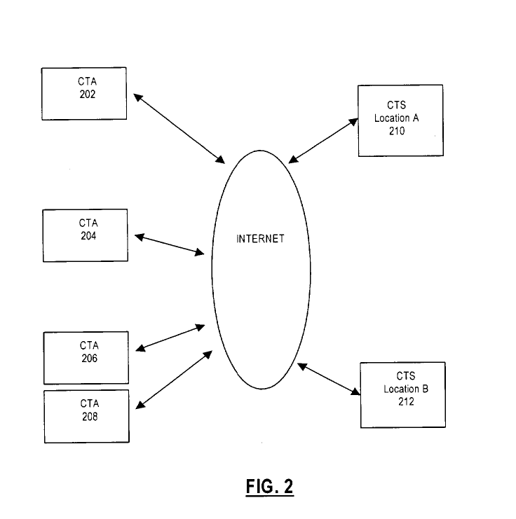

FIG. 2 depicts a shared redundant platform in accordance with some illustrative embodiments;

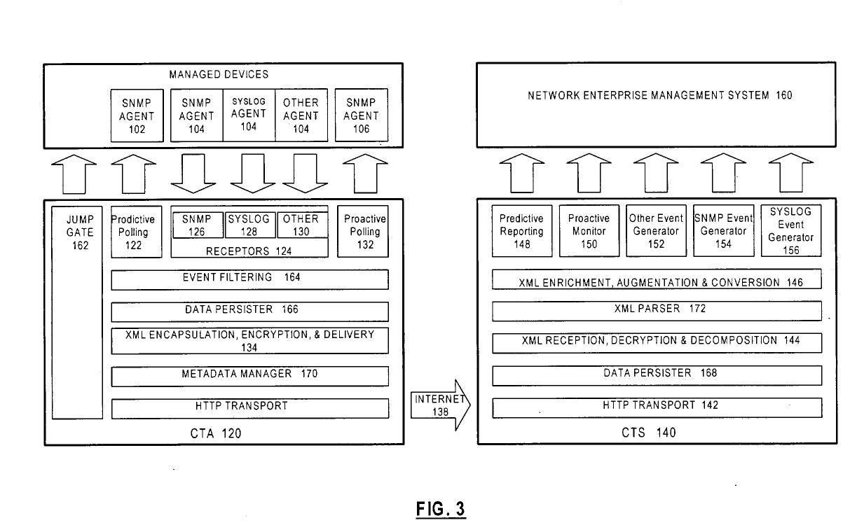

FIG. 3 illustrates the information flow and key components in an embodiment of the present invention using a customer jump gate;

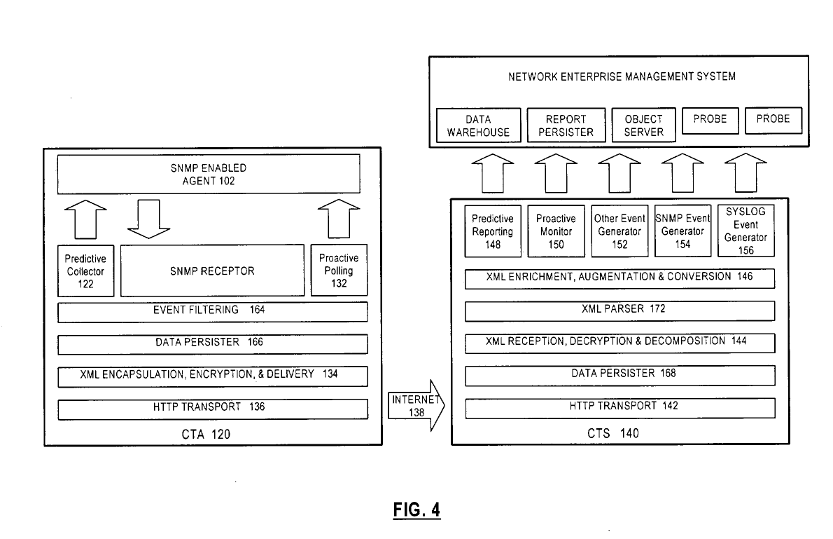

FIG. 4 illustrates the information flow and key components in an embodiment of the present invention using a software-only deployment;

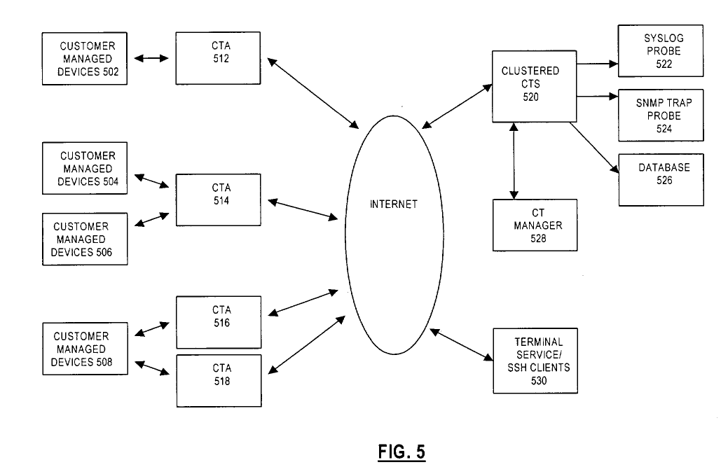

FIG. 5 provides an illustrative system view of the present invention; and

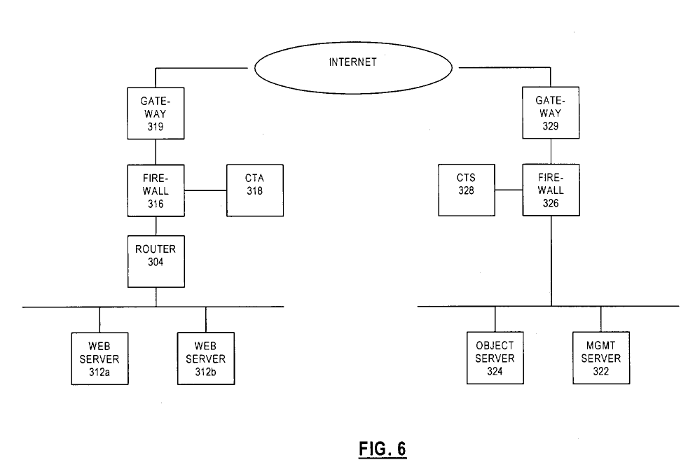

FIG. 6 provides an illustrative configuration of the present invention for a single customer.

### DETAILED DESCRIPTION OF THE INVENTION

FIG. 1 shows an information flow in accordance with some illustrative embodiments of the present invention. The event delivery system 100 in accordance with embodiments of the present invention may include two main components. First is a client receiver platform 120 (hereafter “control tower appliance” 120 or “CTA” 120) which is preferably a rack mountable platform deployed in a client cage which provides store and forward of event information and a secure management jump gate to reach client hosts. The CTA 120 maybe deployed in one-to-one, one-to-many, or many-to-one configurations depending on customers/partners environment. Second is an event delivery server 140 (hereafter a “control tower server” 140 or “CTS” 140) which provides a unified and/or centralized event delivery mechanism for all CTA's and other future service platforms. The CTS provides an extensible open standard based delivery platform of event information into core systems. A single CTS will preferably support many customers and is easy to scale with additional computing resources. In general, information about events to be monitored or managed flows from the information source(s) (hereafter “agents”) to a CTA 120 and then to a CTS 140, from which the information is then passed to appropriate network management tools.

In some embodiments, applications will include those developed in Java. Java provides cross platform support and access to many libraries that already support various protocols used by event delivery system 100. This approach also provides a high degree of software re-use and the possibility of creating new products such as monitoring solutions requiring zero in cage hardware footprint.

Preferably, CTA 120 and CTS 140 will use extended markup language (XML) to share data and configuration information between various components. XML has many advantages over proprietary formats including its ability to be extended without reengineering applications. Preferably, the event delivery system 100 will define a XML schema to describe event information. This schema will allow any application that supports HTTP and XML to deliver events into particular systems (e.g., into SevenSpace systems in some embodiments).

As shown in FIG. 1, the event delivery system 100 includes the CTA 120 that receives reactive, proactive and/or predictive event information from at least one of managed device agents 102, 104, and 106. The CTA 120 preferably includes several lightweight software components, while these components are preferably targeted to be executed on the CTA platform, they could easily be executed on customer or partner hosts or the like to provide zero or substantially zero hardware footprint monitoring in cases where the customer only requires monitoring, or monitoring and reporting, on servers.

Devices produce reactive event information, for example, when they encounter an error or reporting condition. Reactive events are typically delivered in SNMP, Syslog or other suitable formats. SNMP/Syslog formats may be considered unreliable due to their delivery being over the UDP/IP protocol. Proactive events, for example, can be produced by an external entity (such as a CTA) polling the device to check its health. Predictive events, for example, can be produced by an external entity (again, such as a CTA) polling the device to collect performance metrics of the target device. Reactive, proactive and predictive events are collected by the client application using appropriate native protocols, such as SNMP trap, SNMP, Syslog, RMON, Internet Control Message Protocol (ICMP) Ping and/or the like.

The CTA 120 includes reactive event receptors 124, which collect asynchronous events from monitored devices. Preferably, specific receptors may be developed to support the core monitoring technologies deployed. These may include a SNMP receptor 126 and an Syslog receptor 128. Using this model, the CTA 120 can be easily extended to support other future monitoring technologies, accommodated in a receptor 130. Preferably, events reported from agents 102, 104 and/or 106 are delivered over UDP transport. UDP does not make provision for the sender to attempt retransmission should the receptor be blocked and is not able to process the inbound event. To minimize the risk of losing events, each receptors function will be limited to receiving the event and queuing in the native format for additional processing.

The function of a predictive collector 122 is to perform SNMP polling operations to collect the appropriate values that are queued for delivery. Preferably, a CTS deferred reporting engine 154 breaks these requests back into the appropriate format for queuing in a data warehouse, which is included within enterprise network management system 160. In preferred embodiments, performing in this manner allows CT to preserve a near real time reporting capability.

A proactive polling module 132 provides a heartbeat module that delivers predictive monitoring. A heartbeat helps identify a properly functioning system from a disabled system. For example, if the receptors are not receiving events from a customer device, one of the following scenarios is true: the device is healthy and is not attempting to send events; or the device is hard down and not capable of generating events. Proactive polling element 132 gives an extra level of confidence that customer hosts are alive by performing SNMP “pings” of agents ensuring that, e.g., both the TCP/IP stack and agents are alive. Preferably, the heartbeat will send the results of the “ping” to CTS 140 via an event delivery process. This information can be used to present up/down information on monitored systems and also validated by a CTS proactive monitor 150 to ensure the CTA 120 has checked in within an appropriate window and all monitored servers are well.

With the successful reception of event data from the managed devices to the CTA 120, an XML encapsulation, encryption and delivery module 134 then begins a delivery phase to transport the data to, a set of data monitoring and management tools. Each type of event received is encapsulated, such as, e.g., in the form of an XML message using predefined XML schemas. The XML message is encrypted, preferably using a common encryption protocol such as, for example, Counterpane™ Blowfish, Data Encryption Standard (DES), RSA encryption, or the like. Preferably, encrypted XML messages are delivered via HTTP protocol between CTA 120 and CTS 140. Should the connection between the CTA 120 and CTS 140 be unavailable, or the link quality be deemed unsuitable for transport, the CTA 120 will preferably first look for alternative CTS servers located in diverse locations. Moreover, if these are not available, the CTA 120 will preferably act in a store and forward mode until such time that the link is of sufficient quality to deliver event information.

An HTTP transport module 136 is responsible for the actual delivery of events from CTA 120 to CTS 140. It preferably operates on the push paradigm and only requires an outbound channel from the customer's network to CTS 140 to operate. Events are encapsulated in either HTTP or HTTPS protocol for delivery. As discussed above, confidentiality of the event traffic leaving the CTA 120 is maintained by having the XML message is encrypted before transmission. Thus, the system can achieve benefits of HTTPS without the overheads associated with that protocol. Using this mode of operation, the CTA 120 can sustain, in some embodiments, hundreds of events per second. Additionally, the HTTP protocol is also customer friendly in that most customers already permit outbound HTTP connections through their firewalls.

Data from the CTA 120 is passed via an Internet transport 138 to the CTS 140. (The data path between the CTA 120 and the CTS 140 is further depicted in FIG. 6.) Referring still to FIG. 1, while the CTS 140 may be designed to support the CTA 120 information, its open nature allows, e.g., simple integration with future monitoring technologies. These include, e.g., new agents and data collection products. The CTS 140 may also be deployed in multiple locations to provide geographic failover or event routing or the like.

An HTTP transport module 142 in the CTS 140 performs the actual receiving of events from the CTA 120 to the CTS 140. Data is passed from HTTP transport module 142 to an XML reception, decryption, and decomposition module 144 for further processing with the CTS 140.

The XML reception, decryption, and decomposition module 144 provides a reception and decomposition layer to ensure the successful delivery and acknowledgement of information from the CTA 120. Prior to an acknowledgement being issued, a md5 checksum of the data or other method of checksum is preferably performed of each event to ensure its consistency. Should the event fail its consistency check, the CTS 140 will preferably issue a failure status causing the event to be re-queued by the CTA 120 for retry delivery. Preferably, as the CTS 140 receives each message, an acknowledgement is provided to the client instructing it that the message was both received and undamaged in transport. At this point, the client is permitted to remove the message from its outbound queue.

An event conversion, augmentation, enrichment module 146 may include some or all of the following features. Preferably, events are received by the server (CTS) application delivered over the HTTP protocol. The integrity and confidentially of these events are validated by the CTS application in module 146. Confirmation of successful reception is provided to the CTA application. CTS application decrypts event message to its XML message format. The XML message is augmented and enriched with additional contextual information. Preferably, conversion of any values such as IP addresses or host name references is performed by an XSL translation.

The proactive monitor 150 provides both a remote health check of all CTA/monitored devices and the simple up/down state of the device (e.g., shown by, for example, Spyglass or other proprietary applications that allow a client to view information stored in the CTA). In this regard, the heartbeat monitor preferably interfaces both with a client viewing application (e.g., Spyglass) and an object server. An object server provides a database that holds information to be presented to operators of the enterptise monitoring system tools so that new events can be identified and acted upon as they arrive. Preferably, should the heartbeat monitor detect a CTA that has not checked in within a pre-determined time or a customer's device that also has not checked in, an event can be generated to create an alert (e.g., to alert an operations center of the outage).

The enriched XML message is converted to its original native format (typically, SNMP trap, Syslog or another format) before being presented to tools supporting these native protocols (e.g., enterprise monitoring system) for presentation to analysts for evaluation. A predictive reporting module 148 inserts reporting data captured by the CTA 120 into a system (e.g., SevenSpace) data warehouse where it is available for reporting and trending.

When the originating device delivers events via SNMP to the CTA 120, it is necessary to enrich these events before presenting to the operations center. In this mode of operation, an SNMP event generator 154 reconstitutes the SNMP as an SNMP trap which looks identical to the event arriving at CTA 120 with any changes made during transformation. The event generator 154 preferably sends to a local probe within enterprise network management system 160 that contains rules to set severity and augment with any local inventory information. Preferably, address translation is performed at this point to cover customers who may have overlapping address spaces.

Per a similar model as the SNMP event generator 154, raw Syslog information is often too generic to be presented to a GMOC engineer for evaluation. In a Syslog event generator 156, the event is preferably reconstituted as a Syslog message and delivered to the local Syslog probe for evaluation against the Syslog rule set. Preferably, address translation is performed at this point to cover customers who may have overlapping address spaces. A similar process is also used for an other events generator 152.

Using the CTA 120 and CTS 140, event data is successfully and securely transferred from the managed devices to the enterprise network management system 160. The enterprise network management system 160 comprises a variety of data management tools known in the art to monitor, manage and report event data.

In preferred embodiments, the CTA 120 includes a rack mountable server with minimal CPU, memory and/or disk requirements and that allows a variety of vendors to be considered. In some embodiments, the operating system can be, e.g., a custom Linux® distribution built to support specific CTA functions with all redundant applications stripped away. This distribution can be, e.g., heavily fortified with security features such as, e.g., IPCHAINS stateful inspection firewall, SSH, Tripwire and/or appropriate file system permissions to lock down the functions further. In addition, a journaling file system is preferably selected which may improve both performance and reliability of the platform.

CTS 140 provides a highly scalable platform to support event delivery and/or preferred polling support. A variety of server platforms may be used for CTS 140. In some embodiments, e.g., Sun Solaris based servers can be used to support the CTS 140 platform. These servers can run, e.g., Apache® web server with java servlet support.

FIG. 2 provides an illustration of a how the present invention can be configured with a shared redundant platform. Data from managed devices collected at CTA's 202, 204, 206, and 208 is passed via the Internet to CTS one of two CTS locations 210 and 212. In this configuration, the CTS is deployed in multiple locations to provide geographic failover or event routing. For example, the system may be configured with a default that sends data from CTA 202 to CTS location 210. If the connection to CTS location 210 is interrupted or if CTS location 210 is otherwise inoperable, data from CTA 202 can alternatively be sent to CTS location 212. As another example, the system may be configured with defaults so that a particular type of data (e.g., proactive polling data) is sent to CTS location 210, while another data type (e.g., reactive SNMP data) is sent to CTS location 212. However, all data could be sent to one CTS, in the event of a failure at one of either CTS location 210 or 212.

FIG. 3 illustrates the information flow and key components of an event delivery system using a customer jump gate and other additional modules. Refer to jump gate module 162. A management company may require full management access to customer devices to perform fault remediation and root cause analysis. Management access can provide a number of challenges from both IP connectivity and security fronts. Use of CTA 120 can solve these issues by, e.g., using soft VPN's between metaframe management hosts distributed across the management company's infrastructure directly to the CTA 120. Once connected and authentication has taken place, CTA 120 may provide a jump point to manage customer devices. This approach can, e.g., resolve the need for network address translation to be performed since CTA 120 can, e.g., both have a public Internet address and be connected to, e.g., the customer's locally allocated address space defined by, for example, RFC1918.

In preferred embodiments, CTA 120 supports at least some, preferably all, of the following management protocols:

| Protocol | Use |
|---|---|
| Telnet | Basic network equipment (such as, |
| | e.g., Cisco) |
| SSH | Unix based hosts and encryption |
| | aware network devices |
| X | Unix hosts requiring X-windows |
| | management tools |
| Virtual Network Computing (VCN) | Support for VNC including tightlib |
| | compression and encryption and |
| | Windows and Unix platforms |
| Window Terminal Services (RDP) | Windows 2000 |
| HTTP/S | Launching web browsers to locally |
| | adminstrate appliations (such as, |
| | e.g., Netscape admin server) |
| PCAnywhere | Support for Windows servers |
| | running PCAnywhere protocols |

Jump gate 162 can be used to unify these access methods to a single host to simplify remote support.

Refer now to event filtering module 164 of FIG. 3. Most devices capable of generating events make no provision to selectively chose events to send other than basic severity level settings. Event filter 164 provides a mechanism to squelch types of events or hosts from delivering information to the CTS 140. In some embodiments, filtered events are defined using XML showing the event schema field to search for and the string to match within the field. These strings may be expressed, e.g., as regular expressions to provide multiple matching (wildcards).

A data persistence layer 166 permits CTA 120 to operate in store-and-forward mode should the Internet connection to the CTS become unavailable. In this mode, the CTA 120 queues events for future delivery to ensure no events are lost in transit. In some embodiments, persister 166 only permits events from being “dequeued” on confirmation of event reception from the CTS 140. Thus, the system may be used to provide reliable delivery of events over potentially unreliable transport (such as, e.g., over the Internet). Each event is acknowledged by the CTS 140 on reception and only at this time are events “dequeued” by the persister. Corresponding to data persister 166, data persister 168 in the CTS 140 performs the same function for information transmissions from the CTS 140 back to the CTA 120.

CTA requires several items of metadata to describe a customer environment and support core operations. This may include, e.g., inventory information, address translation, polling intervals and/or values to be collected by the data collector. Collection and processing of this data is accomplished through metadata manager 170. Preferably, all metadata within the CT is stored in XML format. Among other things, this may provide a high degree of portability and/or easy interaction with CT components. In preferred embodiments, metadata is hosted on the CTS and transferred to the CTA on startup and configuration changes. Among other things, this mode of operation may allow for rapid swap outs of hardware should a failure occur.

In some illustrative embodiments, substantially any management company's support personnel with knowledge of the customer's systems will be able to provision the CTA 120. Preferably, the CTA 120 accomplishes such flexibility by the custom Linux® distribution being preloaded onto each CTA in base configuration. On first boot of the server, a series of questions will preferably drive the addressing, configuration and/or startup of CTA 120. Once deployed to a customer, CTA 120 will immediately make contact with the management company pushing its configuration back for archival. Should the CTA 120 suffer hardware failure, a process will preferably be provided to activate this backed up configuration on a clean box before reshipping. This automated approach minimizes deployment and support activities and leverages customer engineers who have detailed knowledge of a particular deployment.

Finally, FIG. 3 also depicts an XML parsing module 172 in CTS 140. XML parser 172 intercepts inbound messages from CTA and selects the appropriate interpreter to handle the data. This may be accomplished, e.g., by interpreting the XML data type field to select the correct handler to process the event.

Turning now to FIG. 4, FIG. 4 depicts an embodiment of the present invention using a substantially software deployment. In many cases, it is desirable to deploy the monitoring/reporting features of CT without or substantially without the additional cost of deploying a hardware solution. Particularly, for example, if a monitoring and/or management company is performing service on a limited number of hosts, a third party is providing the hands on remediation or is trailing such services.

In some embodiments, re-using the lightweight components of the CTA architecture, it is possible to deploy a minimal interface to allow the monitoring application agent (such a SysEdge™ agent) to fully interoperate with a CTS over the Internet using only push technology. This requires no inbound access to the customer network. Using this mode of operation allows a monitoring and/or management company to leverage its investment in the monitoring application and the effort in building out application specific configuration files to customers who do not warrant the deployment of a server solution.

In this model, the monitoring application may be configured to send event SNMP traps to its loop back address (back to itself without traversing down to the physical layer) where the receptor would process the event and deliver to the CTS. Moreover, the data collector and heartbeat modules may be deployed to provide proactive reporting and proactive monitoring services. In preferred embodiments, the overhead should be minimal and should comfortably run on many web, database and/or application server(s).

FIG. 5 provides an illustrative system view of the control tower applied in a multiple client environment. Generally, CTA's maybe deployed in one-to-one, one-to-many, or many-to-one configurations depending on customers/partners environment. In FIG. 5, Customer Managed Device (CMD) 502 is connected in a one-to-one relationship with CTA 512. CMD 504 and CMD 506 are connected with CTA 514 in an exemplary one to may relationship, so that both customers are able to report events from managed devices to single a CTA. A one-to-many relationship may be useful, for example, for customers with combined number of managed devices below the connection capacity of the CTA hardware to provide hardware cost savings. CMD 508 is connected with CTA in an exemplary many-to-one relationship, so that a single customer provides reporting data to more than one CTA. A many-to-one relationship may be useful, for example, for a customer who has a total number of devices that exceeds the connection capacity of a single CTA.

Still referring to FIG. 5, data to and from CTA's 512, 514, 516, and 518 may be securely transported via the Internet to a cluster of CTS's 520, including one or more CTS's. A single CTS will preferably support many customers and is easy to scale with additional computing resources. Data from each CMD 502, 504, 506, and 508 may be directed to an appropriate a local probe within a set of enterprise network management tools, such as Syslog probe 522 or SNMP trap probe 524. Customer data may also be routed to a local database connected to CTS cluster 520. Additionally, operations of CTS cluster 520 may be managed by a separate control tower manager 528 that is operatively connected to CTS cluster 520. Rather than to a CTS, data from CTAs 512, 514, 516, and 518 may also be securely transported via the Internet to a thin client architecture 530, such as Terminal Services or SSH clients.

FIG. 6 provides an illustrative configuration for a single customer using the present invention. Event data from a customer web servers 312a and 312b and from router 314 are passed to the customer's CTA 318. Reactive events are typically delivered to CTA 318 in SNMP or Syslog formats. Predictive collection and proactive polling may be delivered from the CTA to a client device via SNMP or ICMP formats. From CTA 318 data is passed over the Internet via a standard outbound HTTP connection through firewall 316 and gateway 319 using XML over HTTP. The data is received at CTS 328 located in a data management center network 320 through gateway 329 and firewall 326. The data is received and reformatted in CTS 328 and provided via TCP database inserts to an object server 324. The data is monitored and analyzed within data management center 320. Information from data management center 320 is provided for access by the client by sending data from Citrix® management server 322 back to CTA 318 via a virtual private network (VPN). Numerous other configurations using combinations of the above protocols, as well as those using different protocols are envisioned within the scope of the present invention.

While exemplary embodiments of the invention have been shown and described herein, it will be obvious to those skilled in the art such embodiments are provided by way of example only. Numerous insubstantial variations, changes, and substitutions will now be apparent to those skilled in the art without departing from the scope of the invention disclosed herein by the Applicants. Accordingly, it is intended that the invention be limited only by the spirit and scope by the claims as they will be allowed.

1. A computer-based system for monitoring and managing event information, comprising:
at least one event recording agent capable of recording events occurring in a computer network;
at least one receiver platform operatively networked to said at least one event recording agent, said at least one receiver platform capable of receiving event information from said at least one event recording agent and providing store and forward services of event information; and
an event delivery server that is remotely networked to said at least one receiver platform and provides a centralized event delivery mechanism for said at least one receiver platform.

2. The system according to claim 1, further comprising at least one network enterprise management tool operatively networked to said event delivery server.

3. The system according to claim 1, wherein said event information is provided to said event delivery server over an Internet connection using at least one of encryption, encapsulation, and delivery confirmation of said event information.

4. The system according to claim 3, wherein an XML schema is defined to describe said event information such that any application that supports HTTP and XML is capable of delivering events.

5. The system according to claim 1, wherein said event information is at least one of reactive, predictive and proactive.

6. The system according to claim 1, wherein said at least one receiver platform receives said event information in an unreliable protocol and forwards said event information in XML via HTTP.

7. The system according to claim 6, wherein said at least one recording agent uses at least one of SNMP, Syslog, and ICMP protocols.

8. The system according to claim 1, wherein management access to client devices from said event delivery server is provided through said at least one receiver platform using soft virtual private networks over an Internet connection.

9. The system according to claim 8, wherein said management access is conducted using a virtual private network (VPN).

10. The system according to claim 1, wherein said at least one receiver platform provides local filtering capabilities to eliminate transmission of unnecessary event data.

11. The system according to claim 10, wherein said unnecessary event data is defined according to an predetermined XML schema.

12. A computer-based system for monitoring and reporting event information, comprising:
means for recording event information in a computer network;
means for converting said event information into a secure format for transmission over an Internet connection;
means for storing said converted event information; and
means for forwarding said converted event information to an event delivery server that is remotely networked to said recording means.

13. A method of monitoring and reporting computer-based event information, comprising the steps of:
recording event information in a computer network;
converting said event information into a secure format for transmission over an Internet connection; and
storing said converted event information; and
forwarding said converted event information to an event delivery server that is remotely networked to said computer network.

14. The method of claim 13, wherein said recording step includes receiving event information from a plurality of devices.

15. The method according to claim 13, further comprising the step of restoring said converted event data into its original format.

16. The method according to claim 15, further comprising the step of forwarding said decrypted event information to at least one network enterprise management tool operatively networked to said event delivery server.

17. The method according to claim 13, wherein said step of converting event information includes using at least one of encryption, encapsulation, and delivery confirmation of said event information.

18. The method according to claim 13, further comprising the step of defining an XML schema to describe said event information such that any application that supports HTTP and XML is capable of delivering events.

19. The method according to claim 13, wherein said steps of converting and storing are conducted using at least one receiver platform and management access to client devices from said event delivery server is provided through said at least one receiver platform using soft virtual private networks over said Internet connection.

20. The method according to claim 13, wherein said event information is at least one of reactive, predictive and proactive.

21. The method according to claim 20, wherein said step of recording is performed using at least one of SNMP, Syslog, and ICMP protocols and wherein said step of forwarding is performed using XML encapsulation.
